(19) United States
(12) Patent Application Publication
(10) Pub. No.: US 2025/0211476 A1
(43) Pub. Date: Jun. 26, 2025

(54) METHOD TO ENHANCE RAYLEIGH AND GAUSSIAN SENSITIVITY OF DIGITAL AUDIO BROADCAST RECEIVERS

(71) Applicant: INNTOT TECHNOLOGIES PRIVATE LIMITED, Kerala (IN)

(72) Inventors: Abdul Sameeh PARANGODATH, KERALA (IN); DILEEP ACHUNNI PARVATHI, KERALA (IN); GEETHU STANLY, KERALA (IN)

(73) Assignee: INNTOT TECHNOLOGIES PRIVATE LIMITED, Kerala (IN)

(21) Appl. No.: 18/439,307

(22) Filed: Feb. 12, 2024

(30) Foreign Application Priority Data
Dec. 22, 2023 (IN) 202341088363

(51) Int. Cl. H04L 27/26

(52) U.S. Cl. CPC H04L 27/265; H04L 27/2614

(57) ABSTRACT

The present invention relates to enhance Gaussian and Rayleigh sensitivity performance of Digital Audio Broadcast receivers by the following method: The channel impulse response (CIR) peak estimator (101) retrieves the peak positions (102, 103) of the channel impulse response. A set of complex samples of length K are formed from the K complex samples. FFT of size K (104, 105) is evaluated to generate frequency domain samples which are differentially demodulated (DQPSK) (106, 107) to estimate the subcarrier level QPSK symbols (108), marked as r1k (109). The K complex samples beginning from the second peak position (103) are collected. FFT of size K (104, 105) is evaluated on this set of complex samples, whose output is differentially demodulated (DQPSK) to estimate the second set of subcarrier level QPSK symbols r2k. Subcarrier QPSK combination is performed on r2k (110) and r1k (109) to produce the resultant K complex samples (111) of the demodulator.

### FIELD OF INVENTION

The present invention relates to the field of Digital Audio Broadcast receivers, more specifically to a method for enhancing Gaussian and Rayleigh sensitivity performance of Digital Audio Broadcast receivers.

### BACKGROUND OF THE INVENTION

Digital broadcast radios use digital technology for transmission and reception of signals over the radio spectrum. Digital broadcast radios are high-quality digital replacements for analogue radio broadcasts. Digital Audio Broadcast (DAB) is one of the standards for digital broadcast radios and is used for transmission in VHF-III band.

DAB radios use digital technology for transmission and reception of signals over the radio spectrum. The following are the features of DAB radios.
DAB radio supports both audio and data.
DAB radio provides good audio quality.
DAB radio provides a greater number of services in a single frequency.
DAB radio utilizes Orthogonal Frequency Division Multiplexing (OFDM) and pi/4-Differential Quadrature Phase Shift Keying (pi/4-DQPSK) as the underlying technologies to broadcast the modulated digital bitstream over the air.

In order to achieve excellent audio and data reception quality, the DAB standard mandates the user receiver to meet certain minimum performance requirements. A couple of the requirements are for Gaussian Sensitivity and Rayleigh Sensitivity which essentially means, the receiver should be able to successfully process over-the-air signals above a stipulated signal level. The figure of merit used for successful processing in the physical layer during the receiver benchmark testing is the Bit Error Rate (BER). The BER is assessed by transmitting a predetermined modulated bitstream from standard test equipment to the Device-Under-Test (DUT). The DUT then estimates the bitstream after demodulation and channel decoding. The estimated bitstream is compared to the predetermined bitstream sent by the transmitter and BER is evaluated. For satisfactory BER performance, the demodulation and channel decoding algorithms need to be robust. When the BER performance is satisfactory, the receiver can achieve a better range at site edges and a better multipath performance.

A detailed overview of the working of the digital broadcast radio receiver is given as: Digital broadcast radio signal is received through the antenna. Digital broadcast radio receiver can be tuned to a frequency using the tuner and the Digital broadcast radio signal is processed using the processor. The audio and data are outputted through Output Devices after processing. The processor contains ASRC (Arbitrary Sample Rate Converter), Demodulator, Channel splitter, Channel decoder, and Middleware & Application. ASRC component will convert the tuned Digital broadcast radio signal sample rate to the sample rate of the Demodulator. The demodulator processes baseband signal and converts it to encoded bitstreams. Fast Fourier Transform (FFT) is a part of the demodulation procedure necessitated to be done at the receiver to generate frequency domain samples. FFT is an efficient method to compute the Discrete Fourier Transform. Demodulator output data is split into different channels by channel splitter. The channel split data is decoded by the channel decoder. Middleware will parse the channel-decoded data and process it as audio and data. The application sends processed data to output devices (speaker & display).

The DAB (Digital Audio Broadcast) signal is formed by a sequence of frames. Each frame is constituted by a NULL symbol, then a special OFDM symbol called as Phase Reference Symbol (PRS), and then another sequence of OFDM symbols. Each OFDM symbol has a cyclic prefix of length L and a subsequent set of K complex samples. Values of L and K are equal to 504 and 2048 in DAB Transmission mode 1.

The different blocks of the demodulator are: Frame Synchronisation, OFDM Symbol Synchronisation, FFT, Differential demodulation, and Frequency Synchronization. The Demodulator receives the DAB radio signal after the sample rate conversion. The complex samples are frame synchronized to estimate the position of the NULL symbol in the sequence. As the next step, the DAB complex symbols are time synchronized to estimate the start of the OFDM symbol. To estimate the start of the OFDM symbol, the received samples are correlated with PRS to derive channel impulse response (CIR). The channel impulse response peak estimator retrieves the peak positions of the channel impulse response. The maximum peak position of the channel impulse response gives the start of the OFDM symbol. Samples in the cyclic prefix are dropped and a set of complex samples of length K (K is the number of frequency subcarriers in the DAB transmission mode) are formed from the next K complex samples. As a subsequent step, FFT of size K is evaluated to generate frequency domain samples. The frequency domain samples of successive OFDM symbols are differentially demodulated (DQPSK) to estimate the subcarrier level QPSK symbols.

A few patents related to the above-discussed field are given below:

CA2763134C (System and method for controlling combined radio signals) relates to controlling a combined signal, for example, to reduce its peak-to-average power ratio or an inferred error at a receiver. But the present invention relates to a system in the receiver to achieve better sensitivity performance.

U.S. Pat. No. 8,638,655B2 (Systems and method for orthogonal frequency divisional multiplexing) relates to a remote unit using frequency guard bands in a multipoint-to-point communication system in which orthogonal frequency division multiplexed carriers are used for carrying upstream and downstream communications, and in which more than one remote unit, after receiving allocations of orthogonal frequency division multiplexed carriers for upstream communications, may transmit upstream communications that are received at a host at the same time. This patent relates to a multiplexing scheme between a host unit and multiple remote units. But the present invention relates to a method to achieve better Sensitivity performance.

The present invention relates to a method to enhance Gaussian and Rayleigh sensitivity performance of Digital Audio Broadcast receivers by evaluating Fast Fourier Transforms (FFT) at multiple positions of OFDM symbols and then computing differential demodulation and subsequently combining post differential demodulation subcarrier constellation symbols.

### OBJECTIVE OF THE INVENTION

Objective of the present invention is to provide enhanced Gaussian and Rayleigh sensitivity by evaluating Fast Fourier Transforms (FFT) at multiple positions of OFDM symbols and then computing differential demodulation and subsequently combining post differential demodulation subcarrier constellation symbols.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing and the claims, and the abstract, as a whole.

The aim of the present invention is to enhance Gaussian Sensitivity and Rayleigh Sensitivity thereby achieving better site-edge performance and multipath performance. Digital broadcast radio receiver can be tuned to a frequency using the tuner and the Digital broadcast radio signal is processed using the processor. The processor contains ASRC, a Demodulator, a Channel splitter, Channel decoder, and Middleware and application. ASRC component will convert the tuned Digital broadcast radio signal sample rate to the sample rate of the Demodulator. The demodulator processes baseband signal and converts it to encoded bitstreams. FFT is a part of the demodulation procedure necessitated to be done at the receiver to generate frequency domain samples. Demodulator output data is split into different channels by channel splitter. The channel split data is decoded by the channel decoder. Middleware will parse the channel-decoded data and process it as audio and data. The application sends processed data to output devices (speaker & display).

DAB signal is formed by a sequence of frames. Each frame is commenced by a NULL symbol, then a special OFDM symbol called as Phase Reference Symbol (PRS), and then another sequence of OFDM symbols. Each OFDM symbol has a cyclic prefix of length L and a subsequent set of K complex samples. Values of L and K are equal to 504 and 2048 in DAB Transmission mode 1. The different blocks of the demodulator are Frame Synchronisation, OFDM Symbol Synchronisation, FFT, Differential demodulation, and Frequency Synchronization. The Demodulator receives the DAB radio signal after the sample rate conversion. The complex samples are frame synchronized to estimate the position of the NULL symbol in the sequence. As the next step, the DAB complex symbols are time synchronized to estimate the start of the OFDM symbol. To estimate the start of the OFDM symbol, the received samples are correlated with PRS to derive the channel impulse response. The channel impulse response peak estimator retrieves the peak positions of the channel impulse response. The maximum peak position of the channel impulse response gives the start of the OFDM symbol. Samples in the cyclic prefix are dropped and a set of complex samples of length K (K is the number of frequency subcarriers in the DAB transmission mode) are formed from the next K complex samples. As a subsequent step, FFT of size K is evaluated to generate frequency domain samples. The frequency domain samples of successive OFDM symbols are differentially demodulated (DQPSK) to estimate the subcarrier level QPSK symbols. Where the set of complex samples is marked as r1k.

The second peak position in the channel impulse response is additionally utilized in the present method. The K complex samples beginning from this peak position are collected. FFT of size K is evaluated on this set of complex samples. Output frequency domain samples of successive OFDM symbols corresponding to this FFT are again differentially demodulated (DQPSK) to estimate the second set of subcarrier level QPSK symbols r2k. Subcarrier QPSK combination is performed on r2k and r1k. The resultant K complex samples of the demodulator are then processed by the channel splitter and subsequently, channel-decoded to retrieve the information bit stream.

### BRIEF DESCRIPTION OF THE DRAWINGS

The manner in which the present invention is formulated is given a more particular description below, briefly summarized above, may be had by reference to the components, some of which are illustrated in the appended drawing is to be noted; however, the appended drawing illustrates only typical embodiments of this invention and are therefore should not be considered limiting of its scope, for the method may admit to other equally effective embodiments.

Throughout the drawings, the same drawing reference numerals will be understood to refer to the same elements and features.

The features and advantages of the present invention will become more apparent from the following detailed description along with the accompanying FIGURES, which form a part of this application and in which:

FIG. 1: Block Diagram describing the method in accordance with the present invention;

### REFERENCE NUMERALS

100—OFDM (Orthogonal Frequency Division Multiplexing) symbol sync
101—CIR peak estimator
102—K samples Starting from first peak position
103—K samples Starting from second peak position
104, 105—FFT (Size K)
106, 107—Differential Demodulation
108—Subcarrier QPSK combiner
109—r1k
110—r2k
111—K samples

### DETAILED DESCRIPTION OF THE INVENTION

The principles of operation, design configurations, and evaluation values in these non-limiting examples can be varied and are merely cited to illustrate at least one embodiment of the invention, without limiting the scope thereof.

The embodiments disclosed herein can be expressed in different forms and should not be considered as limited to the listed embodiments in the disclosed invention. The various embodiments outlined in the subsequent sections are constructed such that it provides a complete and thorough understanding of the disclosed invention, by clearly describing the scope of the invention, for those skilled in the art.

Throughout this specification, various indications have been given as to preferred and alternative embodiments of the invention. It should be understood that it is the appended claims, including all equivalents, which are intended to define the spirit and scope of this invention.

In the present invention, the below procedure is annexed to the demodulator procedure described in the background of the present invention:

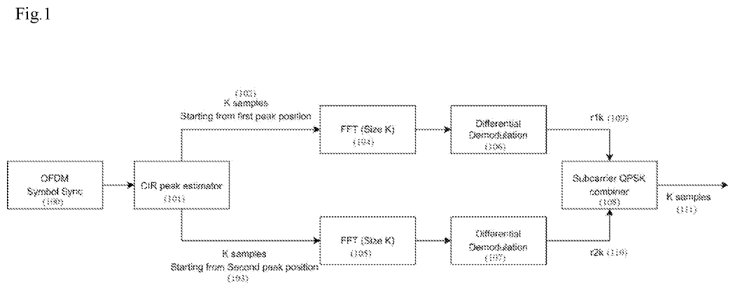

The channel impulse response peak estimator (101) retrieves the peak positions of the channel impulse response. Samples in the cyclic prefix are dropped and a set of complex samples of length K (K Is the number of frequency subcarriers in the DAB transmission mode) are formed from the next K complex samples. As a subsequent step, FFT of size K is evaluated to generate frequency domain samples. The frequency domain samples of successive OFDM symbols (100) are differentially demodulated (DQPSK) (106, 107) to estimate the subcarrier level QPSK symbols (108). This set of complex samples is marked as r1k (109). The second peak position in the channel impulse response is additionally utilized in one embodiment of the present invention. The K complex samples beginning from this peak position are collected. FFT of size K is evaluated on this set of complex samples. Output frequency domain samples of successive OFDM symbols (100) corresponding to this FFT are again differentially demodulated (DQPSK) to estimate the second set of subcarrier level QPSK symbols r2k (110) as displayed in FIG. 1. Subcarrier QPSK combination (108) is performed on r2k (110) and r1k (109). The resultant K complex samples (111) of the demodulator are then processed by the channel splitter and subsequently, channel-decoded to retrieve the information bit stream.

In another embodiment of the present invention, the method can be extended by utilizing more than two peaks from the channel impulse response and adding corresponding computational blocks FFT, DQPSK, and subcarrier QPSK combiner (108). In another embodiment of the present invention, the method can also be generalized to transmission schemes that involves OFDM (100) and Differential Multi Phase Shift Keying (DMPSK) instead of DQPSK.

The present invention improves Rayleigh Sensitivity and Gaussian Sensitivity by 0.2 dB or more in comparison to the scheme without incorporating the method of the present invention.

Gaussian Sensitivity and Rayleigh Sensitivity are part of the minimum receiver requirements mandated to be satisfied by the DAB receiver. The present invention improves the Gaussian Sensitivity and Rayleigh Sensitivity performance of DAB receivers. Usage of one embodiment of the present invention in DAB receiver systems shown to give a performance enhancement of Gaussian Sensitivity and Rayleigh Sensitivity by 0.2 dB or more.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Indian Application No. 202341088363, filed Dec. 22, 2023, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method to enhance Gaussian and Rayleigh sensitivity performance of Digital Audio Broadcast (DAB) receivers, the method comprises the steps of:
evaluating Fast Fourier Transforms (FFT) at multiple positions of Orthogonal Frequency Division Multiplexing (OFDM) symbols (100);
computing differential demodulation and subsequently combining post differential demodulation subcarrier constellation symbols;
retrieving peak positions (102, 103) of a channel impulse response using the channel impulse response peak estimator (101);
dropping samples in a cyclic prefix and forming a set of complex samples of length K, where K is a number of frequency subcarriers in a DAB transmission mode are formed from the next K complex samples;
evaluating a subsequent step FFT of length K to generate frequency domain samples;
differentially demodulating the frequency domain samples of successive OFDM symbols (100) to estimate subcarrier level Quadrature Phase Shift Keying (QPSK) symbols and the set of complex samples are marked as r1k (109);
wherein a second peak position in the channel impulse response is additionally utilized and the K complex samples beginning from the second peak position are collected;
evaluating FFT of size K (104, 105) on the K complex samples;
differentially demodulating output frequency domain samples of successive OFDM symbols (100) corresponding to this FFT to estimate a second set of subcarrier level QPSK symbols r2k (110);
performing Subcarrier QPSK combination (108) on r2k (110) and r1k (109); and
processing the resultant K complex samples (111) of the demodulator are then processed by the channel splitter and subsequently, the channel decoded to retrieve the information bit stream.

2. The method to enhance Gaussian and Rayleigh sensitivity performance of Digital Audio Broadcast receivers, as claimed in claim 1, wherein, the method includes can be extended by utilizing more than two peaks from the channel impulse response and adding corresponding computational blocks FFT, DQPSK (106, 107) and the subcarrier QPSK combiner.

3. The method to enhance Gaussian and Rayleigh sensitivity performance of Digital Audio Broadcast receivers, as claimed in claim 1, wherein, the method includes can also be generalized to transmission schemes which involves OFDM and Differential Multi Phase Shift Keying (DMPSK) instead of DQPSK.

4. A method to enhance digital audio broadcast (DAB) receivers, the method comprising:
receiving a plurality of peak positions of a channel impulse response at a channel impulse response peak estimator;
forming a first set of K samples starting from a first peak position;
forming a second set of K samples starting from a second peak position;
evaluating Fast Fourier Transforms (FFT) of the first set of K samples and the second set of K samples to generate frequency domain samples;
differentially demodulating using demodulators the frequency domain samples of successive OFDM symbols to estimate subcarrier level QPSK symbols to mark the first set of K samples as r1k and the second set of K samples as r2k;
performing subcarrier combination on r1k and r2k; and
processing the K complex samples of the demodulators to retrieve an information bit stream.
